(19) United States
(12) Patent Application Publication
(10) Pub. No.: US 2013/0050587 A1
(43) Pub. Date: Feb. 28, 2013

(54) LIGHTING DEVICE, DISPLAY DEVICE AND TELEVISION RECEIVER

(71) Applicant: Yuuki Namekata, Osaka-shi (JP)

(72) Inventor: Yuuki Namekata, Osaka-shi (JP)

(21) Appl. No.: 13/695,326

(22) PCT Filed: Mar. 10, 2011
(86) PCT No.: PCT/JP2011/055598

§ 371 Date: Oct. 30, 2012

(30) Foreign Application Priority Data
May 25, 2010 (JP) 2010-119348

(51) Int. Cl. G09F 13/04; H04N 5/66

(52) U.S. Cl. 348/739; 362/97.1; 348/E05.133

(57) ABSTRACT

The technology of the present invention provides a lighting device in which uneven brightness is less likely to occur. The backlight unit 12 includes an LED board 18 on which an LED 17 as a light source is mounted, a chassis 14 including a bottom plate 14a arranged on a side of the LED 17 that is opposite to a light exit side, and a LED board holder 20 fixed to the bottom plate 14a such that the LED board 18 is sandwiched between the LED board holder 20 and the bottom plate 14a. The LED 17 is arranged such that the bottom plate 14a of the chassis 14 includes at least one arrangement area LA of the LED 17 and at least one non-arrangement area LN of the LED 17. The LED board holder 20 includes a light leading portion 22 protruding toward the light exit side that is opposite to the LED board 18 side and leading the light toward the light exit side.

### TECHNICAL FIELD

The present invention relates to a lighting device, a display device, and a television receiver.

### BACKGROUND ART

A liquid crystal panel used for a liquid crystal display device such as a liquid crystal television does not emit light, and thus a backlight unit is required as a separate lighting device. The backlight unit is provided behind the liquid crystal panel (on a side opposite to a display surface). The backlight unit includes a chassis, a light source, an optical member (a diffuser sheet or the like), and a reflection sheet. The chassis has an opening on a side of the liquid crystal panel. The light source is housed in the chassis. The optical member is provided over the opening of the chassis for efficiently introducing light emitted from the light source toward the liquid crystal panel. The reflection sheet faces the optical member and is configured to reflect the light toward the opening of the chassis. An LED may be used as the light source of the backlight unit. In such a case, the chassis houses an LED board on which the LED is mounted.

One example of the backlight unit including the LED as the light source is disclosed in Patent Document 1.

### RELATED ART DOCUMENT

### Patent Document

Patent Document 1: Japanese Unexamined Patent Publication No. 2006-120644

### Problem to be Solved by the Invention

In order to reduce thickness of the above liquid crystal display device including the LED board, a distance between the optical member and the LEDs needs to be reduced. However, if the optical member is located closer to the LEDs, the optical member is irradiated with light emitted from the LEDs before the light is sufficiently diffused. Accordingly, there is a large difference in brightness between an area where the LEDs are arranged and an area where no LEDs are arranged, and thus uneven brightness may occur in the light exiting from the optical member. Further, the number of LEDs may be reduced in order to reduce the power consumption and the production cost of the liquid crystal display device. In such a case, the LEDs adjacent to each other have a large interval therebetween. Accordingly, there is a large difference in brightness between the arrangement area of LEDs and the non-arrangement area of LEDs, and thus uneven brightness may occur.

### DISCLOSURE OF THE PRESENT INVENTION

The present invention was made in view of the above circumstances. It is an object of the present invention to suppress uneven brightness.

### Means for Solving the Problem

A lighting device according to the present invention includes a light source, a light source board on which the light source is mounted, a chassis housing the light source board and including a bottom plate on which the light source board is arranged, and a light source board holder. The bottom plate of the chassis includes at least one arrangement area in which the light source is arranged and at least one non-arrangement area in which no light source is arranged. The light source board holder is fixed to the bottom plate in the non-arrangement area such that the light source board is sandwiched between the light source board holder and the bottom plate. The light source board holder includes alight leading portion protruding toward a light exit side so as to be away from the light source board. The light leading portion is configured to lead the light from the light source toward the light exit side.

In this configuration, the light source board holder is fixed to the bottom plate such that the light source board is sandwiched between the light source board holder and the bottom plate, and thus the light source board is fixed to the chassis. In the chassis, the amount of light in the arrangement area where the light source is arranged is likely to be relatively large and the amount of light in the non-arrangement area where no light source is arranged is likely to be relatively small. In the present invention, the light source board holder is provided in the non-arrangement area, and the light source board holder includes the light leading portion protruding toward the light exit side so as to be away from the light source board. In the non-arrangement area where the amount of light is likely to be small, the light leading portion leads the light emitted from the light source toward the light exit side. This supplements the amount of light exiting from the non-arrangement area. With this configuration, the difference between the amount of light exiting from the arrangement area of the light source and the amount of light exiting from the non-arrangement area of the light source, i.e., the brightness difference, is less likely to occur, and thus, the uneven brightness in the exiting light is less likely to occur.

The reduction in the uneven brightness in the exiting light as above can lead the reduction in the thickness of the lighting device, for example. Further, the number of light sources can be reduced, and thus the power consumption and the production cost of the lighting device can be reduced.

In the present invention, the light source board holder for holding the light source board includes the light leading portion. Compared with the lighting device including the light leading portion as a separate member from the light source board holder, the number of members and the number of assembly steps can be reduced. This can reduce the production cost.

The following configurations are preferable as aspects of the present invention.

(1) The light leading portion may include an inclined surface inclined with respect to a surface of the bottom plate and oriented to the arrangement area. With this configuration, the light emitted from the light source arranged in the arrangement area can have an angle corresponding to the inclination angle of the inclined surface. Thus, the light can efficiently exit from the non-arrangement area of the light source. This efficiently supplements the amount of light exiting from the non-arrangement area, and thus, the uneven brightness is less likely to occur.

(2) The light source may include a plurality of light sources and the at least one arrangement area includes at least two arrangement areas. The at least two arrangement areas may be located to sandwich the at least one non-arrangement area therebetween. The inclined surface may include a pair of inclined surfaces and each of the inclined surfaces is oriented to each of the at least two arrangement areas located to sandwich the non-arrangement area therebetween. With this configuration, the light emitted from the light sources arranged in the arrangement areas located with the non-arrangement area therebetween is efficiently led toward the light exit side by the inclined surfaces of the light leading portion arranged in the non-arrangement area. This further reduces the uneven brightness.

(3) The inclined surfaces may have a substantially equal inclination angle. With this configuration, the light emitted from the light sources arranged in the arrangement areas located with the non-arrangement area therebetween can be evenly led toward the light exit side by the inclined surfaces in the non-arrangement area.

(4) The light leading portion may have a triangular cross-sectional shape. With this configuration, the inclined surface extends over the entire height of the light leading portion, and thus the light in the non-arrangement area can efficiently exit.

(5) The light leading portion may protrude farther than the light source to be away from the light source board toward the light exit side. With this configuration, compared with the light leading portion having a protruding height substantially the same as a protruding height of the light source, more light emitted from the light source can be led toward the light exit side by the light leading portion. This further reduces the uneven brightness.

(6) The light leading portion may include a surface having white color. With this configuration, high light reflectivity can be obtained, and thus the light can be efficiently led toward the light exit side. This further reduces the uneven brightness.

(7) The light source may include a plurality of light sources. The light sources may be linearly arranged on the light source board to form a light source group. The arrangement area of the light sources may have a band shape extending along an arrangement direction of the light sources in which the light sources included in the light source group are arranged. The light leading portion may extend along the arrangement direction. With this configuration, the light emitted from the light sources included in the light source group arranged in the arrangement area having the band shape can be efficiently led in the non-arrangement area by the light leading portion extending along the arrangement direction of the light sources. Accordingly, the amount of the light exiting from the non-arrangement area can be efficiently supplemented. This reduces the uneven brightness.

(8) The light leading portion may extend parallel with the light source group over an entire length of the light source group. With this configuration, the light emitted from the light sources included in the light source group can be more efficiently led toward the light exit side.

(9) The bottom plate may have an elongated shape. The arrangement direction of the light sources included in the light source group may match a short-side direction of the bottom plate. With this configuration, compared with the case where the arrangement direction of the light sources matches the long-side direction of the bottom plate, the length of the arrangement area is small. Accordingly, the brightness difference between the arrangement area and the non-arrangement area is less likely to occur. This reduces the uneven brightness.

(10) The light source group may include a plurality of light source groups. The light source groups may be spaced apart from each other in a direction intersecting with the arrangement direction of the light sources. The light source board holder may be arranged between adjacent light source groups. With this configuration, the light emitted from the light sources included in the light source groups can be efficiently led toward the light exit side by the light leading portion arranged between the adjacent light source groups. This reduces the uneven brightness. In addition to the reduction in the uneven brightness, the size of the lighting device having this configuration can be made larger than that of the lighting device including only one light source group.

(11) The light source board holder may be arranged at a middle position between the adjacent light source groups. With this configuration, the light emitted from the light sources included in each light source group can be evenly led toward the light exit side by the light leading portion.

(12) The light sources adjacent to each other in the arrangement direction of the light sources have an interval therebetween that is smaller than an interval between the light source groups adjacent to each other. With this configuration, even if the arrangement area has a high density of the light sources, the light in the non-arrangement area can be efficiently led toward the light exit side by the light leading portion. This reduces the uneven brightness.

(13) The interval between the adjacent light sources in the arrangement direction of the light sources may be smaller than an interval between the light source and the light leading portion of the light source board holder. With this configuration, even if the arrangement area has a high density of the light sources, the light in the non-arrangement area can efficiently be led toward the light exit side by the light leading portion. This reduces the uneven brightness.

(14) The light source groups may be arranged in the direction intersecting with the arrangement direction of the light sources at substantially equal intervals. In this configuration, the uneven brightness is less likely to occur compared with the lighting device including the light source groups unevenly arranged.

(15) The light sources included in the light source group may be arranged in the arrangement direction at substantially equal intervals. In this configuration, the uneven brightness is less likely to occur compared with the lighting device including the light sources unevenly arranged.

(16) The lighting device may further include a reflection member covering the light source board from the light exit side. The reflection member is configured to reflect the light emitted from the light source toward the light exit side. With this configuration, the reflection member covering the light source board from the light exit side can efficiently reflect the light emitted from the light sources toward the light exit side. This improves the brightness.

(17) The reflection member and the light source board may be sandwiched between the light source board holder and the bottom plate. With this configuration, in addition to the light source board, the reflection member can be fixed to the chassis by the light source board holder.

(18) The reflection member may have a surface having white color. With this configuration, high light reflectivity can be obtained, and thus the light can be efficiently led toward the light exit side. This further reduces the uneven brightness.

(19) The bottom plate may include a mounting through hole and the light source board holder may include a mounting portion. The mounting portion is inserted to the mounting through hole and is locked by an edge of the mounting through hole. With this configuration, the light source board holder can be stably held.

(20) The mounting portion may include a plurality of mounting portions. The mounting portions may be spaced apart from each other on the light source board holder. With this configuration, the light source board holder cannot be rotated, and thus the light source board can be stably held.

(21) The lighting device may further include an optical member provided on the light exit side so as to face the light source. The optical member is spaced apart from the light leading portion such that a clearance is provided between the optical member and the light leading portion. If there is no clearance between the light leading portion and the optical member, and the light leading portion is in contact with the optical member, the light leading portion in contact with the optical member may be recognized as a dark portion. According to the technology of the present invention, there is a clearance between the light leading portion and the optical member, and thus the light leading portion is less likely to be recognized as the dark portion. This reduces the uneven brightness.

(22) The light source is an LED. With this configuration, improved brightness and lower power consumption, for example, can be achieved.

Next, to solve the above problem, a display device according to the present invention includes the above-described lighting device and a display panel configured to provide display using light from the lighting device.

In such a display device, the lighting device supplying light to the display panel can suppress the unevenness brightness. Thus, high quality display can be achieved.

The display panel may be a liquid crystal panel. The display device as a liquid crystal display device has a variety of applications, such as a television display or a personal-computer display. Particularly, it is suitable for a large screen display.

### Advantageous Effect of the Invention

According to the technology of the present invention, the uneven brightness is less likely to occur.

### BRIEF DESCRIPTION OF THE DRAWINGS

FIG. 1 is an exploded perspective view of a general construction of a television receiver according to the first embodiment of the present invention;

FIG. 2 is an exploded perspective view illustrating a general configuration of a liquid crystal display device included in the television receiver;

FIG. 3 is a plan view illustrating an arrangement of the LED board, the light source board holder, and the reflection sheet in the chassis included in the liquid crystal display device;

FIG. 4 is a cross-sectional view of the liquid crystal display device taken along a short-side direction thereof;

FIG. 5 is a cross-sectional view of the liquid crystal display device taken along a long-side direction thereof;

FIG. 6 is a detailed cross-sectional view of the liquid crystal display device taken along a long-side direction thereof;

FIG. 7 is a cross-sectional view of the light source board holder according to the first modification of the first embodiment;

FIG. 8 is a cross-sectional view of the light source board holder according to the second modification of the first embodiment;

FIG. 9 is a cross-sectional view of the light source board holder according to the third modification of the first embodiment;

FIG. 10 is a plan view illustrating an arrangement of the LED board, the light source board holder, and the reflection sheet according to the second embodiment of the present invention; and

FIG. 11 is a plan view illustrating an arrangement of the LED board, the light source board holder, and the reflection sheet in the chassis according to the third embodiment of the present invention.

### MODE FOR CARRYING OUT THE INVENTION

### First Embodiment

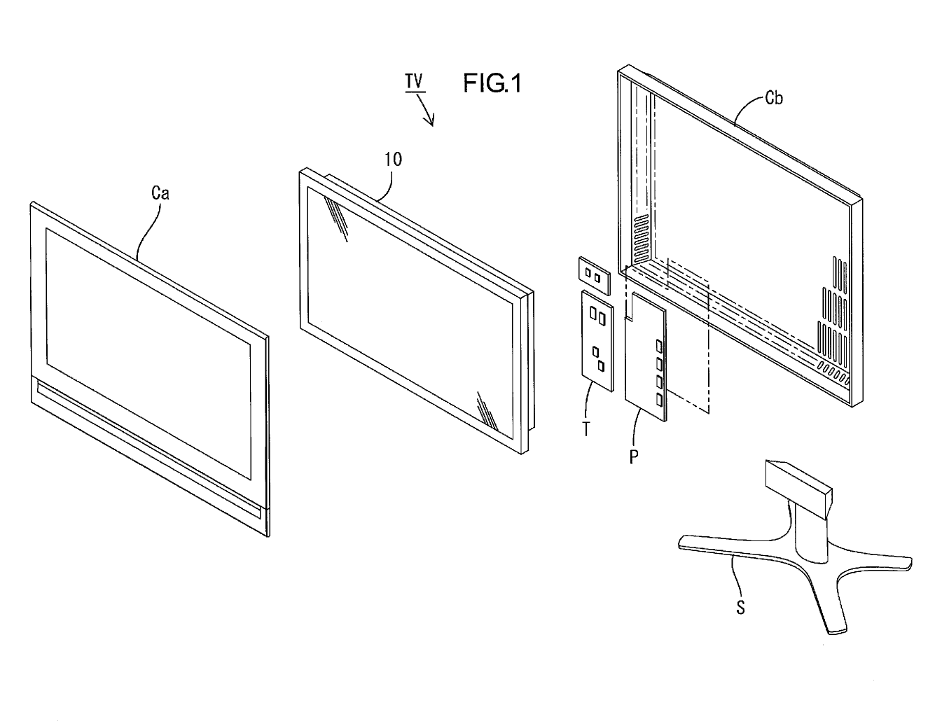

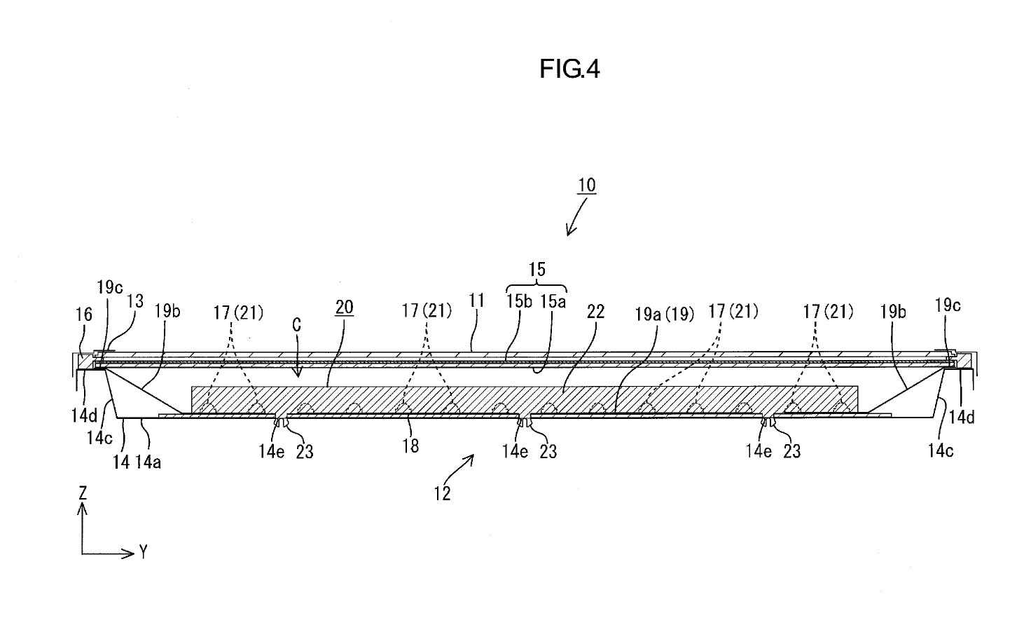

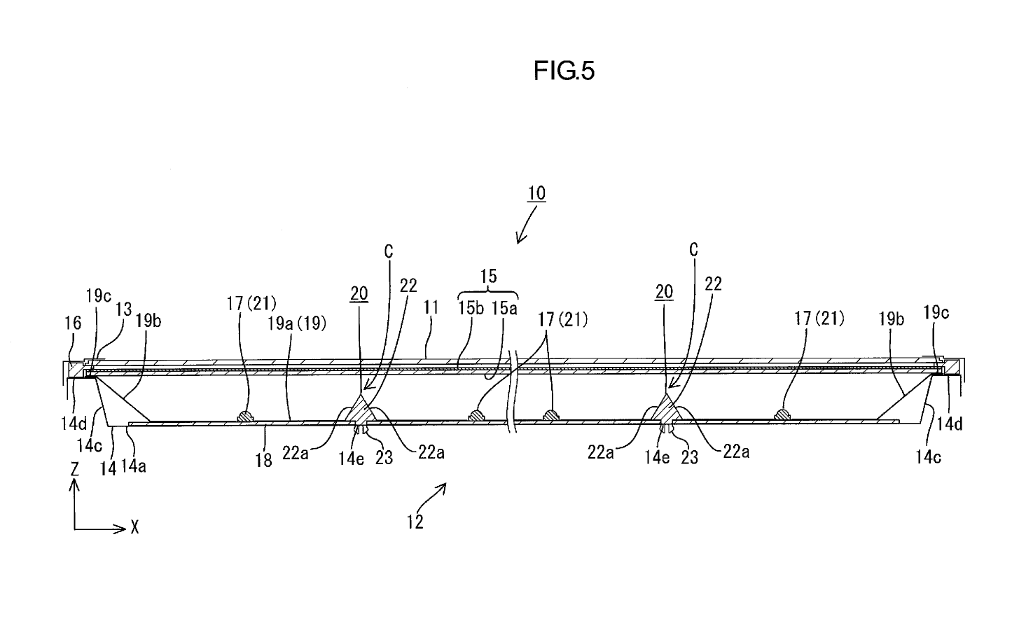

The first embodiment of the present invention will be described with reference to FIG. 1 to FIG. 6. In the present embodiment, a liquid crystal display device 10 will be described. An X-axis, a Y-axis, and a Z-axis are described in a part of the drawings, and a direction of each axial direction corresponds to a direction described in each drawing. An upper side in FIG. 4 and FIG. 5 corresponds to a front-surface side and a lower side in FIG. 4 and FIG. 5 corresponds to a rear-surface side.

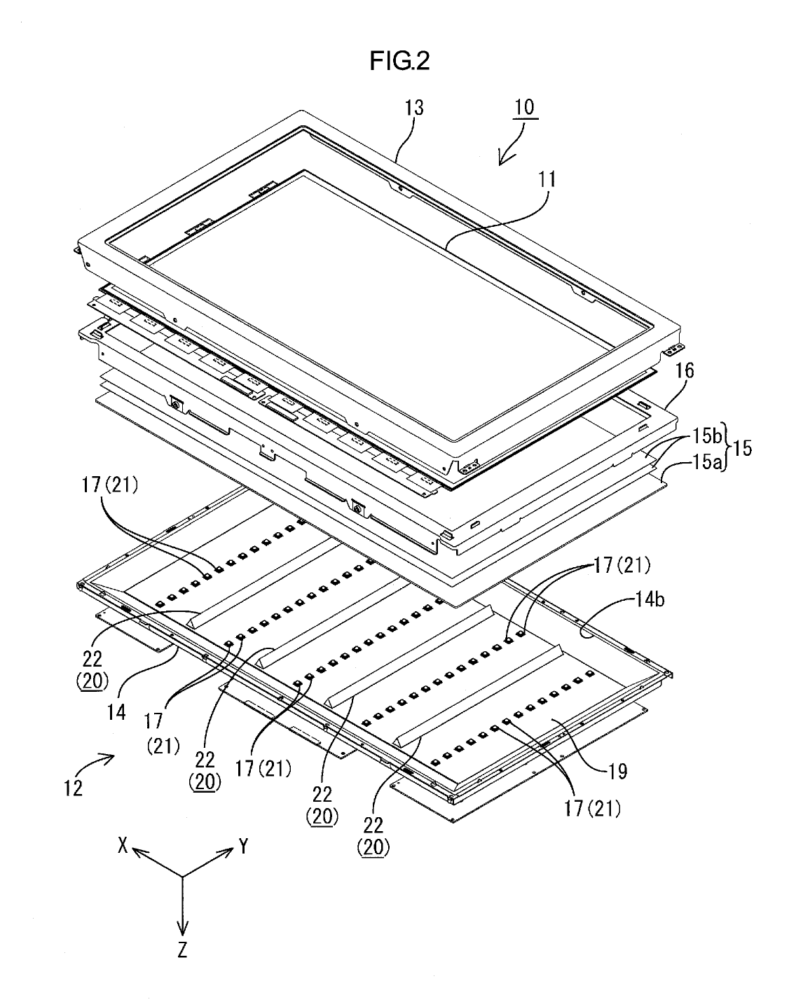

As illustrated in FIG. 1, the television receiver TV of the present embodiment includes the liquid crystal display device 10, front and rear cabinets Ca, Cb which house the liquid crystal display device 10 therebetween, a power source P, a tuner T, and a stand S. An entire shape of the liquid crystal display device (a display device) 10 is a landscape (elongated) rectangular (square) shape. The liquid crystal display device 10 is housed in a vertical position. As illustrated in FIG. 2, the liquid crystal display device 10 includes a liquid crystal panel 11 as a display panel, and a backlight device (a lighting device) 12 as an external light source. The liquid crystal panel 11 and the backlight device 12 are collectively held by a frame shaped bezel 13 and the like.

Next, the liquid crystal panel 11 and the backlight unit 12 included in the liquid crystal display device 10 will be described. The liquid crystal panel (a display panel) 11 is configured such that a pair of glass substrates is bonded together with a predetermined gap therebetween and liquid crystal is sealed between the glass substrates. On one of the glass substrates, switching components (for example, TFTs) connected to source lines and gate lines which are perpendicular to each other, pixel electrodes connected to the switching components, an alignment film, and the like are provided. On the other glass substrate, color filters having color sections such as red (R), green (G), and blue (B) color sections arranged in a predetermined pattern, counter electrodes, an alignment film, and the like are provided. Polarizing plates are arranged on outer surfaces of the substrates.

The backlight unit 12 will be described in detail. As illustrated in FIG. 2, the backlight unit 12 includes a chassis 14, an optical member set 15 (a diffuser plate (a light diffusing member) 15a, optical sheets 15b arranged between the diffuser plate 15a and the liquid crystal panel 11), and a frame 16. The chassis 14 has a substantially box-shape and has an opening 14b on the light exit side (the liquid crystal panel 11 side). The optical member set 15 is provided so as to cover the opening 14b of the chassis 14. The frame 16 provided along an outer edge of the chassis 14 holds an outer edge of the optical sheet set 15 such that the outer edge is sandwiched between the frame 16 and the chassis 14. The chassis 14 houses an LED (Light Emitting Diode) 17 as a light source, an LED board 18 on which the LED 17 is mounted, a reflection sheet 19 reflecting the light in the chassis 14 toward the optical member 15 side, and an LED board holder 20 (a light source board holder) holding the LED board 18 in the chassis 14. As above, the backlight unit 12 according to the present embodiment is a direct-type backlight unit. In the backlight unit 12, a light exit side (of the backlight unit 12) is a side closer to the optical member 15 than the LED 17. Hereinafter, each component of the backlight unit 12 will be described in detail.

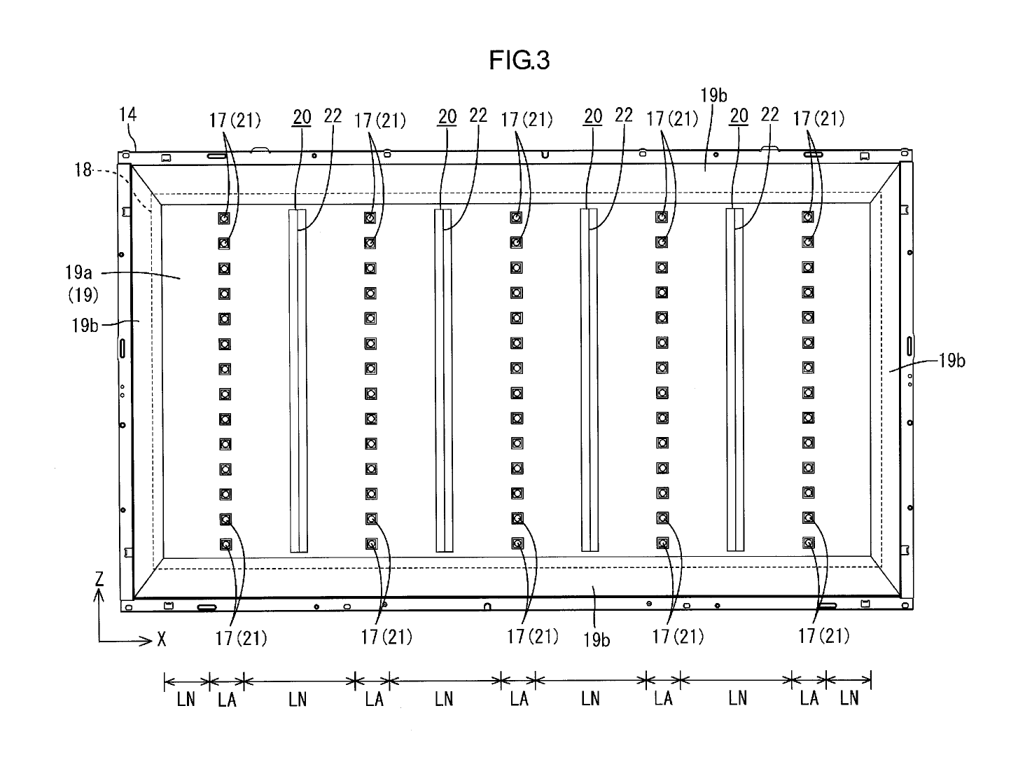

The chassis 14 is made of metal. As illustrated in FIG. 3 to FIG. 5, the chassis 14 includes a bottom plate 14a having a landscape quadrangular (square, rectangular) shape like the liquid crystal panel 11, and side plates 14c each rising from an outer edge of long sides and short sides of the bottom plate 14a toward the front surface side (the light exit side), and receiving plates 14d extend outwardly from upper edges of the side plates 14c. The chassis 14 has a substantially shallow box shape (shallow plate shape) opened to the front surface side as a whole. The long-side direction of the chassis 14 matches the X-axis direction (a horizontal direction), and the short-side direction of the chassis 14 matches the Y-axis direction (a vertical direction). The bottom plate 14a of the chassis 14 is arranged on a rear side of the LED board 18, i.e., on a side opposite to the light exit side of the LED 17. On each receiving plate 14d of the chassis 14, the frame 16 and the optical member 15 which will be described later can be placed from the front surface side. The frame 16 is fixed to the receiving plates 14d with screws.

As illustrated in FIG. 2, the optical member 15 has a landscape quadrangular shape in a plan view like the liquid crystal panel 11 and the chassis 14. As illustrated in FIG. 4 and FIG. 5, outer edge portions of the optical member 15 are placed on the receiving plates 14d so that the opening 14b of the chassis 14 is covered with the optical member 15 and the optical member 15 is arranged between the liquid crystal panel 11 and the LED 17. The optical member 15 is arranged on the front side of the LED 17 such that the optical member 15 faces the LED 17 with a predetermined distance therebetween. The optical member 15 includes the diffuser plate 15a provided on the rear side (the LED 17 side, a side opposite to the light exit side) and the optical sheets 15b provided on the front side (the liquid crystal panel 11 side, the light exit side). The diffuser plate 15a is formed by dispersing light diffusing particles in a substantially transparent resin base member having a predetermined thickness. The diffuser plate 15a diffuses the light transmitting therethrough. Each optical sheet 15b has a sheet-like shape that is thinner than the diffuser plate 15a. The optical sheets 15b and the diffuser plate 15a are laminated on each other. Specific examples of the optical sheets 15b include a diffuser sheet, a lens sheet, and a reflection-type polarizing sheet, and any of them may be suitably selected to be used.

As illustrated in FIG. 2, the frame 16 has a frame shape extending along the outer edge portions of the liquid crystal panel 11 and the optical member 15. The outer edge portion of the optical member 15 can be sandwiched between the frame 16 and each receiving plate 14d (FIG. 4 and FIG. 5). The frame 16 can receive the rear surface of the edge portion of the liquid crystal panel 11, and thus the edge portion of the liquid crystal panel 11 can be sandwiched between the frame 16 and the bezel 13 arranged on the front side (FIG. 4 and FIG. 5).

Next, the LED 17 and the LED board 18 on which the LED 17 is mounted will be explained. As illustrated in FIG. 4 and FIG. 5, the LED 17 is configured by sealing an LED chip with a resin material onto a base board that is fixed to the LED board 18. The LED chip that is mounted on the base board has one main light emission wavelength, and specifically, the LED chip that emits a single color of blue is used. On the other hand, a fluorescent material is dispersed in the resin material that seals the LED chip therein. The fluorescent material converts blue light emitted from the LED chip into white light. This enables the LED 17 to emit white light. The LED 17 is a top-type LED that has a light emitting surface on a surface opposite from the mounting surface that is to be mounted to the LED board 18 (a surface that faces the optical member 15). A light axis of light emitted from the LED 17 matches the Z-axis direction that is a direction perpendicular to a display surface of the liquid crystal panel 11 (a plate surface of the optical member 15).

As illustrated in FIG. 3 to FIG. 5, the LED board 18 has a landscape quadrangular (square, rectangular) shape like the bottom plate 14a of the chassis 14, and the LED board 18 is housed in the chassis 14 so as to extend along the bottom plate 14a such that a long-side direction of the LED board 18 matches the X-axis direction and a short-side direction thereof matches the Y-axis direction. The LED board 18 has a plate like shape extending along the bottom plate 14a. The LED board 18 is arranged on the front side of the bottom plate 14a such that the LED board 18 covers almost entire of the bottom plate 14a. Specifically, the LED board 18 has a size that can cover substantially entire of the middle portion of the bottom plate 14a, i.e., substantially entire of the bottom plate 14a except the edge portion thereof. The LEDs 17 having the above structure are mounted on a surface of the LED board 18 that faces the front-surface side (the surface on the light exit side, the surface facing the optical member 15). As illustrated in FIG. 3, the LEDs 17 are arranged in an array of rows and columns (in a matrix). The X-axis direction of the LED board 18 is a row direction (the long-side direction of the chassis 14 and the LED board 18) and the Y-axis direction of the LED board 18 is a column direction (the short-side direction of the chassis 14 and the LED board 18). The LEDs 17 are connected to the wiring pattern formed on the LED board 18. The wiring pattern is not illustrated in the drawings. Specifically, on the LED board 18, 5 LEDs 17 are arranged in the X-axis direction and 14 LEDs 17 are arranged in the Y-axis direction.

The LEDs 17 (14 LEDs 17) arranged linearly along the Y-axis direction form an LED group 21. As illustrated in FIG. 3, a total of five LED groups 21 is arranged on the LED board 18. The LED groups 21 each including the LEDs 17 arranged along the Y-axis direction are spaced apart from each other in the X-axis direction, i.e., the direction perpendicular to the Y-axis direction that is a direction in which the LEDs 17 are arranged. Specifically, one of the LED groups 21 is arranged on the middle in the long-side direction of the chassis 14, two of the LED groups 21 are each arranged on the edge portion in the long-side direction of the chassis 14, and two of the LED groups 32 are each arranged between the LED group 21 arranged on the middle and each of the LED groups 21 arranged on the edge portion. The LEDs 17 included in one LED group 21 are arranged over substantially entire length in the short-side direction of the bottom plate 14a of the chassis 14. Arrangement pitches of the LEDs 17 included in the LED group 21, i.e., intervals between the adjacent LEDs 17 in the Y-axis direction, are substantially equal. The LEDs 17 adjacent to each other in the Y-axis direction have an interval therebetween that is sufficiently smaller than the interval between the LED groups 21 (the adjacent LEDs 21) adjacent to each other in the X-axis direction. The LED groups 21 (the adjacent LEDs 17) adjacent to each other in the X-axis direction has a substantially equal interval therebetween.

As described above, the LED groups 21 (the LEDs 17) are spaced apart from each other in the X-axis direction, and thus, as illustrated in FIG. 3, the bottom plate 14a of the chassis 14 is divided into an arrangement area LA where the LED groups 21 (the LEDs 17) are arranged along the X-axis direction and a non-arrangement area LN where no LED groups 21 (the LEDs 17) are arranged. The arrangement area LA and the non-arrangement area LN are alternately located in the X-axis direction. Specifically, four non-arrangement areas LN are each located between five arrangement areas LA that are spaced apart from each other in the X-axis direction, and two non-arrangement areas LN are each located adjacent to the arrangement area LA on the end portion such that each non-arrangement area LN is located closer to the end of the bottom plate 14a than the arrangement area LA on the end portion is. The arrangement areas LA and the non-arrangement areas LN each have a vertically long band shape. The width direction (the short-side direction) of each area LA and LN matches the X-axis direction and the length direction (the long-side direction) thereof matches the Y-axis direction. The areas LA and LN each extend along the short-side direction of the bottom plate 14a (a bottom portion 19a) of the chassis 14 (the reflection sheet 19) over the entire short side. The width of each arrangement area LA is smaller than that of each non-arrangement area LN. Specifically, the width of the arrangement area LA is half of or smaller than the half of the width of the non-arrangement area LN, for example, one third to one fourth. The width of each light arrangement area LA is substantially constant. The non-arrangement area LN located between the arrangement areas LA has a relatively large width and the non-arrangement area LN located closer to each end in the X-axis direction has a relatively small width. The width of four non-arrangement areas LN each having a relatively large width is substantially equal and the width of two non-arrangement area LN having a relatively small width is substantially equal. In the present embodiment, the width of the arrangement area LA is larger than the width of the LED 17 in the X-axis direction.

The reflection sheet 19 is made of a synthetic resin and has a surface having white color that provides excellent light reflectivity. As illustrated in FIG. 3 to FIG. 5, the reflection sheet 19 extends over substantially the entire area of an inner surface of the chassis 14. Thus, the reflection sheet 19 can cover almost entire area of the LED board 18 arranged in the chassis 14 from the front side (the light exit side, the optical member 15 side). The reflection sheet 19 is configured to reflect the light in the chassis 14 toward the front side (the light exit side, the optical member 15 side). The reflection sheet 19 extends along the LED board 18 (the bottom plate 14a) and includes a bottom portion 19a, a rising portion 19b, and an extended portion 19c. The bottom portion 19a has a size that can cover substantially the entire area of the LED board 18. The rising portion 19b rises from each of four sides of the bottom plate 19a toward the front side while being inclined with respect to the bottom portion 19a. The extended portion 19c extends outwardly from the edge of each rising portion 19c and is placed on the receiving plate 14d of the chassis 14. The bottom portion 19a of the reflection sheet 19 is arranged so as to cover the front surface of the LED board 18, i.e., the mounting surface of the LEDs 17. The bottom portion 19a of the reflection sheet 19 includes LED through holes 19d at positions overlapping with the LEDs 17 in a plan view. The LEDs 17 are inserted to the LED through holes 19d. The LED through holes 19d are arranged in rows and columns in the X-axis direction and the Y-axis direction (in a matrix) such that the arrangement of the LED through holes 19d corresponds to the arrangement of the LEDs 17. The LED through holes 19d are arranged at substantially the center of the arrangement area LA in the width direction.

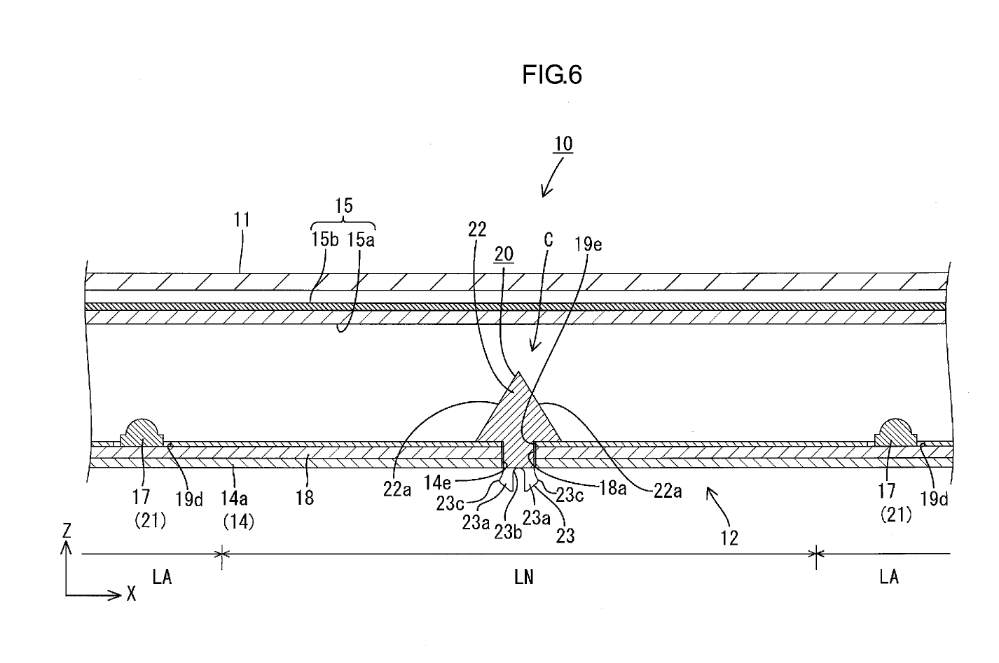

As illustrated in FIG. 3, according to the present embodiment, the LEDs 17 are not evenly distributed on the bottom plate 14a of the chassis 14a. The LEDs 17 are only arranged in the band-shaped arrangement areas LA that are spaced apart in the X-axis direction and are not arranged in the band-shaped non-arrangement area LN that are adjacent to the arrangement area LA in the X-axis direction. Accordingly, in the arrangement area LA, the light emitted from the LEDs 17 is directly applied to the optical member 15 from the LEDs 17. Thus, a relatively large amount of light directly exits toward the liquid crystal panel 11. In the non-arrangement area LN, a relatively small amount of light directly exits toward the liquid crystal panel 11. This may result in the uneven brightness in which the light is unevenly distributed. In the present embodiment, as illustrated in FIG. 3 and FIG. 6, the LED board holder 20 is provided in the non-arrangement area LN of the bottom plate 14a so as to fix the LED board 18 to the chassis 14. Further, the LED board holder 20 includes a light leading portion 22 protruding toward the front side that is the side opposite to the LED board 18 in order to lead the light toward the front side, i.e., the light exit side. Hereinafter, the LED board holder 20 will be explained in detail.

The LED board holder 20 is made of a synthetic resin and has a surface having white color that provides excellent light reflectivity. As illustrated in FIG. 6, the LED board 18 and the bottom portion 19a of the reflection sheet 19 are collectively sandwiched between the LED board holder 20 and the bottom plate 14a of the chassis 14. As illustrated in FIG. 3, one LED board holder 20 is provided in the non-arrangement area LN of the bottom plate 14a of the chassis 14 that are located between the adjacent arrangement areas LA. That is, a total of four light source board holders 20 are provided. Each LED board holder 20 is arranged at substantially the center of each non-arrangement area LN in the width direction (the X-axis direction). In other words, the LED board holders 20 are arranged at substantially the middle position between the adjacent LED groups 21 in the X-axis direction. An interval between the LED board holder 20 and the LED group 21 (the LEDs 17) in the X-axis direction is substantially the half of an interval between the adjacent LED groups 21 and is larger than the interval between the LEDs 17 included in the LED group 21 in the Y-axis direction.

As illustrated in FIG. 4 and FIG. 5, the LED board holder 20 includes the light leading portion 22 and a mounting portion 23. The light leading portion 22 is arranged on the front side of the LED board 18 and the bottom portion 19a of the reflection sheet 19. The mounting portion 23 protrudes from the bottom surface of the light leading portion 22 toward the rear side and passes through mounting through hole 14e of the bottom plate 14a so as to be locked by the edge of the mounting through hole 14e.

As illustrated in FIG. 3 and FIG. 4, the light leading portion 22 has an elongated shape in a plan view linearly extending along the Y-axis direction, i.e., the arrangement direction of the LEDs 17 included in the LED group 21. The light leading portion 22 extends substantially the entire of the bottom portion 19a of the reflection sheet 19 in the short-side direction. The length of the light leading portion 22 is substantially the same as or larger than the length of the LED group 21. As illustrated in FIG. 6, the light leading portion 22 has an inverted V-shape and more protrudes to the front side than the LED 17 protruding to the front side. The front side is opposite to a side where the LED board 18 and the reflection sheet 19 are arranged. The light leading portion 22 protrudes such that a predetermined clearance C is provided between the tip end portion (apex) of the light leading portion 22 and the optical member 15. Specifically, the light leading portion 22 has a height that is a little bit larger than the half of the interval between the bottom portion 19a of the reflection sheet 19 and the optical member 15. Accordingly, the light leading portion 22 is not in contact with the diffuser plate 15a arranged on the rear side in the optical member 15. Even if the diffuser plate 15a is deformed toward the rear side, the light leading portion 22 is not in contact with the diffuser plate 15a. In the above clearance C, the light emitted from the LEDs 17 arranged in the arrangement area LA with the light leading portion 22 therebetween can travel through the clearance C. The bottom surface (the rear surface) of the light leading portion 22 is in contact with the bottom portion 19a of the reflection sheet 19, and thus the bottom portion 19a and the LED board 18 are collectively sandwiched between the light leading portion 22 and the bottom plate 14a of the chassis 14.

As illustrated in FIG. 6, the light leading portion 22 has a triangular shape in a cross section taken along the width direction (the X-axis direction). A pair of side surfaces except for the bottom surface of the light leading portion 22 is a pair of inclined surfaces 22a inclined with respect to the bottom portion 19a (the bottom plate 14a) of the reflection sheet 19 (the chassis 14). The angles of the inclined surfaces 22a with respect to the bottom portion 19a are substantially the same. Preferably, the angle of 45 degrees or more may be employed. Thus, the light leading portion 22 has an isosceles triangle shape in a cross section. The inclined surfaces 22a are oriented to the adjacent arrangement areas LA with the light leading portion 22 therebetween. The inclined surfaces 22a reflect the light toward the front side at an angle corresponding to the angle with respect to the bottom plate 19a. This increases the amount of the light exiting from the non-arrangement area LN.

As illustrated in FIG. 4 and FIG. 5, the mounting portion 23 protrudes from the bottom surface of the light leading portion 22 toward the rear side. The mounting portion 23 is inserted to each mounting through hole 14e of the bottom plate 14a of the chassis 14 and is fixed at the edge of each mounting through hole 14e. Thus, the LED board holder 20 is fixed on the chassis 14. The light leading portion 22 includes three mounting portions 23 so as to be spaced apart from each other in the length direction (the Y-axis direction) thereof. Specifically, the mounting portions 23 are provided at substantially the middle portion and the end portions of the light leading portion 22 in the length direction. With this configuration, the LED board holder 20 is fixed on the chassis 14 such that the LED board holder 20 cannot be rotated. As illustrated in FIG. 6, the groove 23b is provided in the protrusion tip portion of the mounting portion 23 such that elastic stoppers 23a are provided. The elastic stoppers 23a are each cantilevered and deformable toward the inside of the groove 23b while narrowing its width with the innermost of the groove 23b as a fulcrum. The mounting portion 23 includes a stopper 23c at an outer surface of the elastic stopper 23a. The stopper 23c expands toward a side opposite to the groove 23b. Accordingly, when the mounting portion 23 is inserted to the mounting through hole 14e, the elastic stopper 23a is elastically deformed toward the inside of the groove 23b until it reaches a predetermined depth. Then, the elastic stopper 23a is elastically restored and the stopper 23c is locked by the edge of the mounting hole 14e from the outside. Accordingly, the LED board holder 20 is fixed on the chassis 14.

As illustrated in FIG. 4, the mounting through holes 14e are provided in the non-arrangement area LN of the bottom plate 14a so as to overlap with the mounting portions 23 in a plan view. Three mounting through holes 14e are provided in each non-arrangement area LN so as to be linearly arranged along the Y-axis direction. Further, as illustrated in FIG. 6, through holes 18a and through holes 19e to which the mounting portions 23 are inserted are provided in the LED board 18 and the bottom portion 19a of the reflection sheet 19 so as to overlap with the mounting through holes 14e in a plan view.

The construction of the present embodiment has been explained above and an operation thereof will be explained. In the use of the liquid crystal display device 10, the LEDs 17 included in the backlight unit 12 are lit to emit the light. As illustrated in FIG. 4 and FIG. 5, the light emitted from the LEDs 17 is directly applied to the optical member 15 or indirectly applied to the optical member 15 after being reflected by the reflection sheet 19, for example. Then, the light passes through the optical member 15 and exits toward the liquid crystal panel 11. Hereinafter, the light directly applied to the optical member 15 is referred to as direct light and the light indirectly applied to the optical member 15 is referred to as indirect light. The indirect light includes light reflected by the optical member 15 or the front surface of the liquid crystal panel 11 and returned to the inside of the chassis 14. The indirect light is reflected again by the reflection sheet 19 and then applied to the optical member 15.

As illustrated in FIG. 3, on the bottom portion 19a of the reflection sheet 19 facing the optical member 15 in the chassis 14, the LED groups 21 are unevenly arranged. The bottom portion 19a is divided into the arrangement area LA in which the LED group 21 is arranged and the non-arrangement area LN in which no LED group 21 is arranged. With this configuration, when the LEDs 17 are lit, the amount of direct light directly applied to the optical member 15 from the LEDs 17 is relatively large at a portion overlapping with the arrangement area LA in a plan view, but the amount of direct light is relatively small at a portion overlapping with the non-arrangement area LN in a plan view. This may cause distribution unevenness of the light exiting from the optical member 15. However, in the present embodiment, as illustrated in FIG. 3 and FIG. 6, the LED board holder 20 is provided in the arrangement area LA of the bottom plate 14a of the chassis 14 where the amount of light is relatively small. Further, the LED board holder 20 includes the light leading portion 22 protruding toward the front side from the bottom portion 19a of the reflection sheet 19. Accordingly, the light traveling from the LEDs 17 arranged in the arrangement area LA to the non-arrangement area LN is reflected by the surface of the light leading portion 22, and thus the light is led to the light exit side that is the front side. Almost all the light led by the light leading portion 22 is applied as the indirect light to the portion of the optical member 15 overlapping with the non-arrangement area LN in a plan view. This reduces the difference in the amount of light between the portion of the optical member 15 overlapping with the arrangement area LA and the portion of the optical member 15 overlapping with the non-arrangement area LN. As described above, even if the LED groups 21 facing the optical member 15 are unevenly distributed, the amount of light applied to the optical member 15 and the amount of light exiting from the optical member 15 are evenly distributed. Thus, the uneven brightness is less likely to occur.

As illustrated in FIG. 6, the light leading portion 22 includes the pair of inclined surfaces 22a. The inclined surfaces 22a are oriented to the LED groups 21 (the LEDs 17) arranged in the adjacent arrangement areas LA with the non-arrangement area LN (the LED board holder 20) therebetween. With this configuration, the light traveling from the LEDs 17 arranged on each side of the non-arrangement area LN to the non-arrangement area LN can be efficiently led toward the light exit side by the inclined surfaces 22a. Thus, the indirect light can be efficiently supplied to the portion of the optical member 15 overlapping with the non-arrangement area LN. This reduces the uneven brightness. Further, intervals between the light leading portion 22 in the non-arrangement area LN and the LEDs 17 in the arrangement areas LA adjacent to each other with the non-arrangement area LN therebetween are substantially equal. Furthermore, the inclined surfaces 22a have the same inclination angle. Accordingly, the light traveling from the LEDs 17 arranged on each side of the non-arrangement area LN to the non-arrangement area LN can be evenly supplied to the portion of the optical member 15 overlapping with the non-arrangement area LN. This further reduces the uneven brightness. The light leading portion 22 extend in the Y-axis direction, that is the light leading portion 22 extends over the entire length of the LED group 21 along the arrangement direction of the LEDs 17 included in the LED group 21. Thus, the light emitted from the LEDs 17 can be efficiently led toward the light exit side. Further, the clearance C is provided between the light leading portion 22 and the diffuser plate 15a of the optical member 15. The light emitted from the LED groups 21 arranged in the adjacent light arrangement areas LA with the non-arrangement area LN therebetween can travel through the clearance C. Thus, the light leading portion 22 is less likely to be recognized as a dark portion. This also reduces the uneven brightness.

As described above, in the present embodiment, the uneven brightness of the exiting light in the backlight unit 12 is less likely to occur, and thus the following advantages can be obtained. For example, generally, the uneven brightness may easily occur in the backlight unit 12 having small intervals between the LEDs 17 and the optical member 15 in the Z-axis direction, because the light emitted from the LEDs 17 is applied to the optical member 15 without being diffused. However, the employment of the LED board holder 20 according to the present embodiment can suppress the uneven brightness. Thus, the interval between the LEDs 17 and the optical member 15 in the Z-axis direction can be further reduced. This can reduce the thickness of the backlight unit 12 and the liquid crystal display device 10. In addition to the above, generally, the backlight unit 12 including the reduced number of the LEDs 17 may easily have brightness difference between the arrangement area LA and the non-arrangement area LN due to the small arrangement area LA and the large non-arrangement area LN. However, the employment of the LED board holder 20 according to the present embodiment can suppress the uneven brightness. Thus, the number of the LEDs 17 can be reduced and the power consumption and the production cost of the backlight unit 12 and the liquid crystal device 10 can be reduced.

As explained above, the backlight unit 12 of the present embodiment includes the LED board 18 on which the LED 17 as a light source is mounted, the chassis 14 housing the LED board 18 and including the bottom plate 14a, and the LED board holder 20. The LED board holder 20 is fixed to the bottom plate 14a such that the LED board 18 is sandwiched between the LED board holder 20 and the bottom plate 14a. The bottom plate 14a includes the at least one arrangement area LA on which the LED 17 is arranged and the at least one non-arrangement area LN on which no LED 17 is arranged. The LED board holder 20 includes the light leading portion 22 protruding toward the light exit side that is opposite to a side where the LED board 18 is arranged. The light leading portion 22 is configured to lead the light toward the light exit side.

In this configuration, the LED board 18 is sandwiched between the LED board holder 20 and the bottom plate 14a by fixing the LED board holder 20 to the bottom plate 14a, and thus the LED board 18 is held by the chassis 14. Generally, the amount of light in the chassis 14 is likely to be relatively large in the arrangement area LA where the LEDs 17 are arranged and relatively small in the non-arrangement area LN where no LEDs 17 is arranged. However, in the present embodiment, the LED board holder 20 is arranged in the non-arrangement area LN, and further, the LED board holder 20 includes the light leading portion 22 that protrudes farther than the LED board 18 to be away from the LED board 18 toward the light exit side. The light leading portion 22 leads the light emitted from the LED 17 toward the light exit side in the non-arrangement area LN where the amount of light is likely to be small. This supplements the amount of light in the non-arrangement area LN. Accordingly, the difference in the amount of exiting light, i.e., the brightness difference, between the arrangement area LA and the non-arrangement area LN is less likely to occur. This reduces the uneven brightness in the exiting light.

The thickness of the backlight unit 12 can be reduced when the uneven brightness in the exiting light is less likely to occur as described above. In addition, the number of LEDs 17 can be reduced, and thus the power consumption and the production cost of the backlight unit 12 can be reduced.

Further, in the present embodiment, the LED board holder 20 configured to hold the LED board 18 includes the light leading portion 22. Accordingly, compared with the backlight unit 12 including the light leading portion 22 as a separate member from the LED board holder 20, the number of members and the number of assembly steps can be reduced, and thus the cost can be reduced. Further, compared with the case in which, instead of the light leading portion 22 of the LED board holder 20, the part of the reflection sheet corresponding to the non-arrangement area LN is formed into the inverted V-shape to lead the light, the light leading portion 22 of the present embodiment can stably have the inverted V-shape because the light leading portion 22 is included in the LED board holder 20 made of synthetic resin. Thus, the light can be stably and properly led.

The light leading portion 22 includes the inclined surfaces 22a inclined with respect to a surface of the bottom plate 14a and oriented toward the arrangement area LA. With this configuration, the light emitted from the LED 17 arranged in the arrangement area LA can have an angle corresponding to the inclination angle of the inclined surfaces 22a. Thus, the light can efficiently exit from the non-arrangement area LN of the LED. This efficiently supplements the amount of light exiting from the non-arrangement area LN, and thus, the uneven brightness is less likely to occur.

The LED includes a plurality of light sources. The at least one arrangement area LA includes at least two arrangement area. The at least two arrangement areas LA are located to sandwich the at least one non-arrangement area LN therebetween. The inclined surface 22a include a pair of inclined surfaces 22a each of the inclined surfaces 22a is oriented to each of the at least two arrangement areas LA located to sandwich the non-arrangement area LN therebetween. With this configuration, the light emitted from the LEDs arranged in the arrangement areas LA located with the non-arrangement area LN therebetween is efficiently led toward the light exit side by the inclined surfaces 22a of the light leading portion 22 arranged in the non-arrangement area LN. This further reduces the uneven brightness.

The inclined surfaces 22a has a substantially equal inclination angle. With this configuration, the light emitted from the LEDs 17 arranged in the arrangement areas LA located with the non-arrangement area LN therebetween is be evenly led toward the light exit side by the inclined surfaces 22a in the non-arrangement area LN.

The light leading portion 22 has a triangular cross-sectional shape. With this configuration, the inclined surface 22a extends over the entire height of the light leading portion 22, and thus the light in the non-arrangement area LN can efficiently exit.

The light leading portion 22 protrudes farther than the LED 17 to be away from the LED board 18 toward the light exit side. With this configuration, compared with the light leading portion 22 having a protruding height substantially the same as the protruding height of the LED, more light emitted from the LED 17 can be lead toward the light exit side by the light leading portion 22. This further reduces the uneven brightness.

The light leading portion 22 includes a surface having white color. With this configuration, high light reflectivity can be obtained, and thus the light can be efficiently led toward the light exit side. This further reduces the uneven brightness.

The LED 17 includes a plurality of LEDs 17. The LEDs 17 are linearly arranged on the LED board 18 to form the LED group 21. The arrangement area LA of the LEDs 17 has a band shape extending along an arrangement direction of the LEDs 17 in which the LEDs 17 included in the LED group 21 are arranged. The light leading portion 22 extends along the arrangement direction. With this configuration, the light emitted from the LEDs 17 included in the LED group 21 arranged in the arrangement area LA having the band shape is efficiently led in the non-arrangement area LN by the light leading portion 22 extending along the arrangement direction of the LEDs 17. Accordingly, the amount of the light exiting from the non-arrangement area LN can be efficiently supplemented. This reduces the uneven brightness.

The light leading portion 22 extends parallel with the LED group 21 over an entire length of the LED group 21. With this configuration, the light emitted from the LEDs 17 included in the LED group 21 can be more efficiently lead toward the light exit side.

The bottom plate 14 has an elongated shape. The arrangement direction of the LEDs 17 included in the LED group 21 matches a short-side direction of the bottom plate 14a. With this configuration, compared with the case where the arrangement direction of the LEDs 17 matches the long-side direction of the bottom plate 14a, the length of the arrangement area LA is small. Accordingly, brightness difference between the arrangement area LA and the non-arrangement area LN is less likely to occur. This reduces the uneven brightness.

The LED group 21 includes a plurality of LED groups 21. The LED groups 21 are spaced apart from each other in a direction intersecting with the arrangement direction LA of the LEDs 17. The LED board holder 20 is arranged between adjacent LED groups 21. With this configuration, the light emitted from the LEDs 17 included in the LED groups 21 is efficiently led toward the light exit side by the light leading portion 22a arranged between the adjacent LED groups 21. This reduces the uneven brightness. In addition to the reduction in the uneven brightness, the size of the lighting device 12 having this configuration can be made larger than that of the lighting device including only one LED group 21.

The LED board holder 20 is arranged at a middle position between the adjacent LED groups 21. With this configuration, the light emitted from the LEDs 17 included in each LED group 21 is evenly led toward the light exit side by the light leading portion.

An interval between adjacent LEDs 17 in the arrangement direction is smaller than an interval between the adjacent LED groups 21. With this configuration, even if the arrangement area LA has a high density of the LEDs, the light in the non-arrangement area LN can be efficiently led toward the light exit side by the light leading portion. This reduces the uneven brightness.

The interval between the adjacent LEDs 17 in the arrangement direction of the LEDs 17 is smaller than an interval between the LED 17 and the light leading portion 22 of the LED board holder 20. With this configuration, even if the arrangement area LA has a high density of the LEDs 17, the light in the non-arrangement area LN is efficiently be led toward the light exit side by the light leading portion. This reduces the uneven brightness.

The LED groups 21 are arranged in the direction intersecting with the arrangement direction of the LEDs 17 at substantially equal intervals. In this configuration, the uneven brightness is less likely to occur compared with the backlight unit 12 including the LED groups 21 unevenly arranged.

The LEDs 17 included in the LED group 21 are arranged in the arrangement direction at substantially equal intervals. In this configuration, the uneven brightness is less likely to occur compared with the backlight unit 12 including the LEDs 17 unevenly arranged.

The backlight unit 12 further includes the reflection sheet 19 covering the LED board 18 from the light exit side. The reflection sheet 19 is configured to reflect the light emitted from the LED 17 toward the light exit side. With this configuration, the reflection sheet 19 covering the LED board 18 from the light exit side can efficiently reflect the light emitted from the LEDs 17 toward the light exit side. This improves the brightness.

The reflection sheet 19 and the LED board 18 are sandwiched between the LED board holder 20 and the bottom plate 14a. With this configuration, in addition to the LED board 18, the reflection sheet 19 can be fixed to the chassis 14 by the LED board holder 20.

The reflection sheet 19 has a surface having white color. With this configuration, high light reflectivity can be obtained, and thus the light can be efficiently led toward the light exit side. This further reduces the uneven brightness.

The bottom plate 14a includes a mounting through hole 14e and the LED board holder 20 includes a mounting portion 23. The mounting portion 23 is inserted to the mounting through hole 14 and locked by an edge of the mounting through hole 14. With this configuration, the LED board holder 18 can be stably held.

The mounting portion 23 includes a plurality of mounting portions 23. The mounting portions 23 are spaced apart from each other on the LED board holder 20. With this configuration, the LED board holder 20 cannot be rotated, and thus the LED board 18 can be stably held.

The backlight unit 12 further includes an optical member 15 provided on the light exit side so as to face the LED 17. The optical member 15 is spaced apart from the light leading portion 22 such that a clearance is provided between the optical member 15 and the light leading portion 22. If there is no clearance C between the light leading portion 22 and the optical member 15 and the light leading portion 22 is in contact with the optical member 15, the light leading portion 22 in contact with the optical member 15 is recognized as a dark portion. According to the technology of the present invention, there is a clearance C between the light leading portion 22 and the optical member 15, and thus the light leading portion 22 is less likely to be recognized as the dark portion. This reduces the uneven brightness.

The light source is an LED 17. With this configuration, improved brightness and lower power consumption, for example, can be achieved.

In the above description, the first embodiment of the present invention is explained. The present invention is not limited to the above embodiment. The following modifications may be included in the technical scope of the present invention, for example. In the following modifications, similar parts to those in the above embodiment will be indicated by the same symbols and will not be illustrated or explained.

### First Modification of First Embodiment

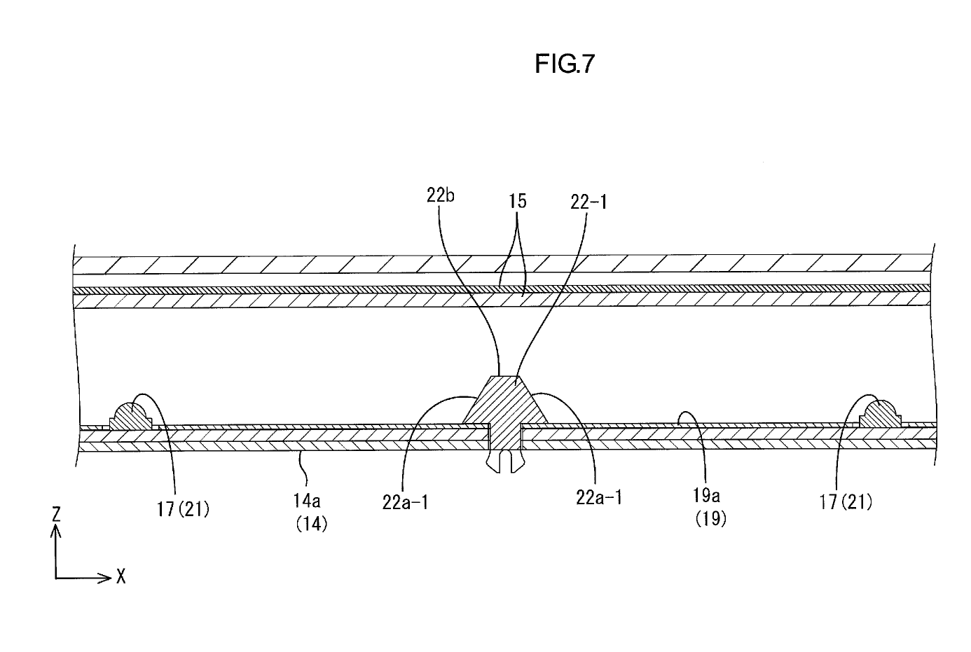

The first modification of the first embodiment will be explained with reference to FIG. 7. The shape of the light leading portion 22-1 is changed.

As illustrated in FIG. 7, the light leading portion 22-1 according to this modification has a trapezoidal cross-sectional shape taken along the width direction of the light leading portion 22-1. The light leading portion 22-1 includes a pair of inclined surfaces 22a-1 and a surface (a surface opposite to the bottom surface) 22b facing the optical member 15. The surface 22b extends parallel with the bottom plate 14a (the bottom portion 19a) of the chassis 14 (the reflection sheet 19). In the light leading portion 22-1 having such a configuration, the light emitted from the LEDs 17 can be efficiently led toward the front side by the surface 22b facing the optical member 15 and the pair of inclined surfaces 22a-1.

### Second Modification of First Embodiment

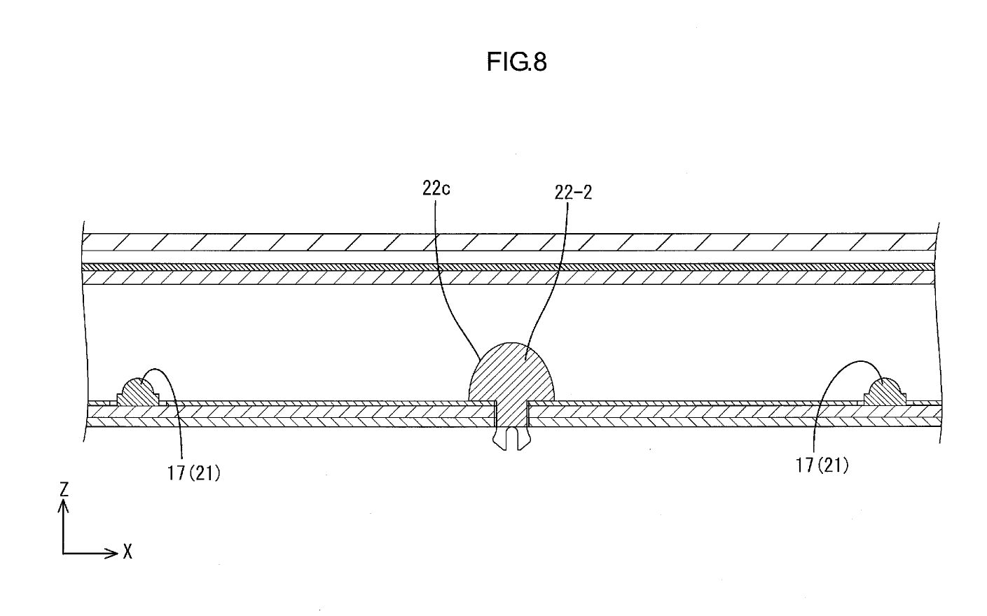

The second modification of the first embodiment will be explained with reference to FIG. 8. The shape of a light leading portion 22-2 is changed.

As illustrated in FIG. 8, the light leading portion 22-2 according to the present modification has a semi-elliptical cross-sectional shape taken along the width direction of the light leading portion 22-2. An outer surface of the light leading portion 22-2 is an expanded circular surface 22c expanding outwardly. In the light leading portion 22-2 having such a configuration, the light emitted from the LEDs 17 can efficiently be led toward the front side by the expanded circular surface 22c.

### Third Modification of First Embodiment

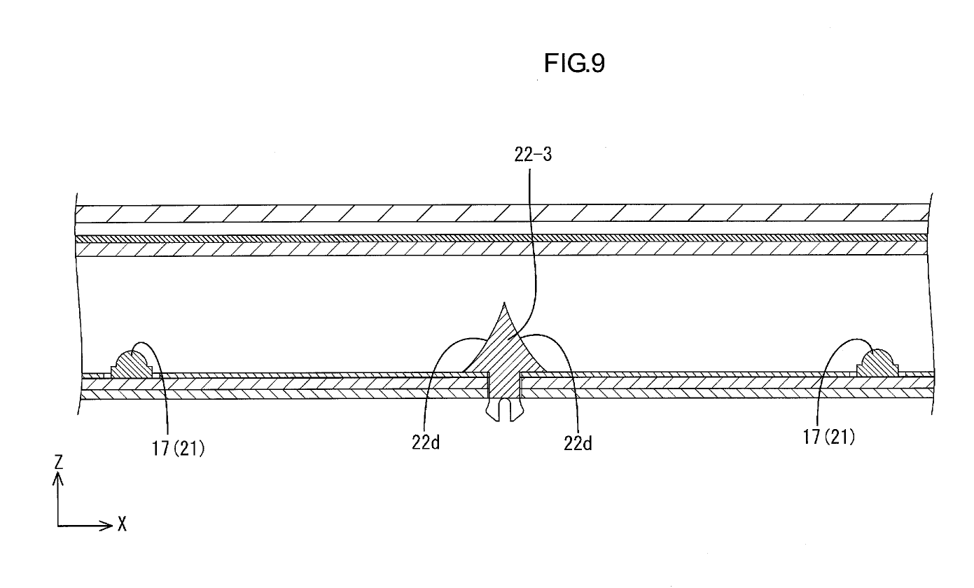

The third modification of the first embodiment will be explained with reference to FIG. 9. The shape of a light leading portion 22-3 is changed.

As illustrated in FIG. 9, the light leading portion 22-3 according to the present modification has a tapered and inverted v-shaped cross-sectional shape taken along the width direction of the light leading portion 22-3. A pair of side surfaces of the light leading portion 22-3 has a depressed circular surface 22d depressed inwardly. In the light leading portion 22-3 having such a configuration, the light emitted from the LEDs 17 can be efficiently led toward the front side by the depressed circular surface 22d.

### Second Embodiment

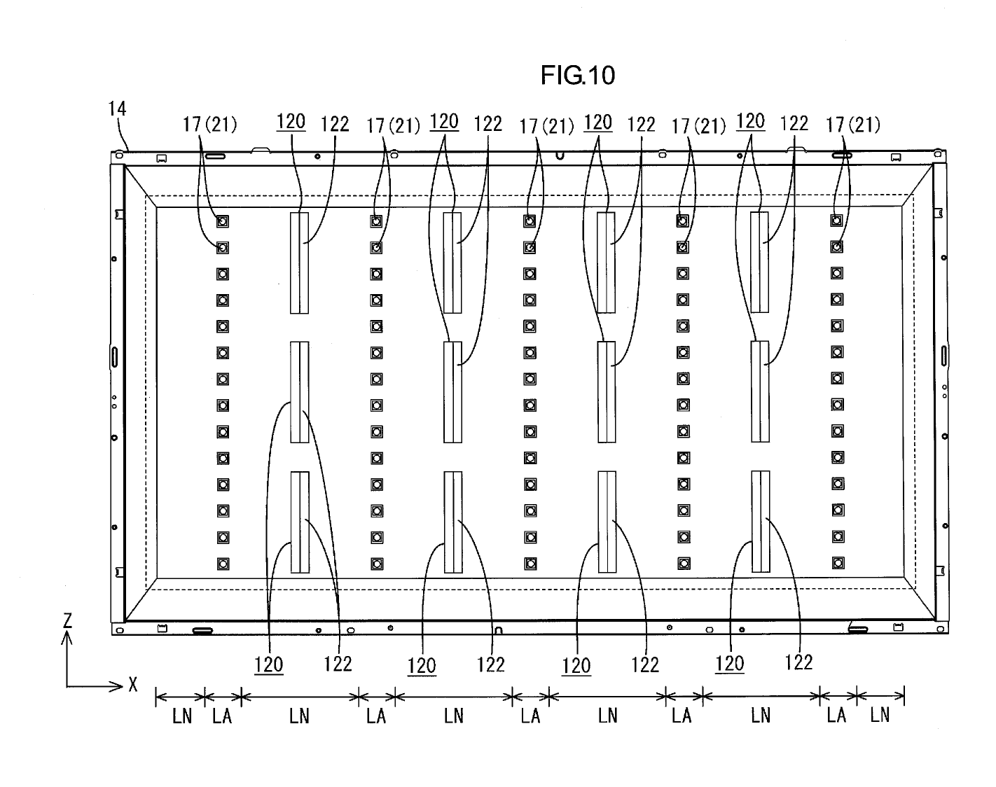

The second embodiment of the present invention will be explained with reference to FIG. 10. In the second embodiment, the size and the number of LED board holders 120 are changed. The construction, operations and effects as same as the first embodiment will not explained.

As illustrated in FIG. 10, the LED board holder 120 according to the present embodiment includes a light leading portion 122 having a length smaller than the length of the LED group 21. Specifically, the length of the light leading portion is about one third of the length of the LED group 21. In each non-arrangement areas LN of the chassis 14, three LED board holders 120 are arranged along the length direction of the non-arrangement area LN (the Y-axis direction) so as to be spaced apart from each other. Namely, in the non-arrangement areas LN of the chassis 14, four LED board holders 120 are arranged along the X-axis direction and three LED board holders 120 are arranged along the Y-axis direction, that is, a total of 12 LED board holders 120 are arranged in rows and columns. Preferably, at least two mounting portions 23 are provided on each LED board holder 120 such that the LED board holder 120 cannot be rotated. The mounting portions 23 are not illustrated.

### Third Embodiment

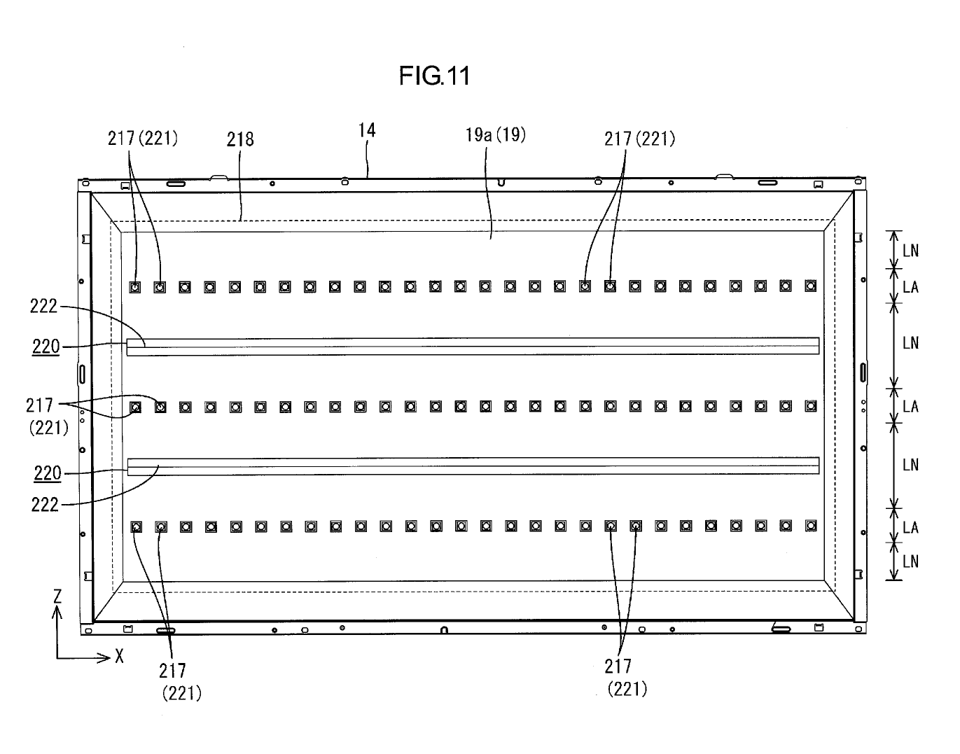

The third embodiment of the present invention will be explained with reference to FIG. 11. In the third embodiment, the arrangement of LED groups 221 on an LED board 218 is changed. The construction, operations, and effects same as the first embodiment will not be explained.

As illustrated in FIG. 11, on the LED board 218 according to the present embodiment, the LED groups 221 including a plurality of LEDs 217 (28 LEDs 217) are provided along the X-axis direction, i.e., the long-side direction of the chassis 14 (the reflection sheet 19). The LED group 221 extends along the long-side direction of the bottom plate 14a (the bottom portion 19a) of the chassis 14 (the reflection sheet 19) over the entire length of the bottom plate 14a. Three LED groups 221 are arranged so as to be spaced apart from each other in the Y-axis direction. That is, three arrangement areas LA are each formed in a landscape band shape extending in the length direction of the LED group 221 and are arranged on the bottom plate 14a of the chassis 14 with a predetermined distance therebetween in the Y-axis direction. The non-arrangement areas LN are each formed in a landscape band shape extending in the X-axis direction, i.e., the arrangement direction of the LEDs 217 included in the LED groups 221. Two of the non-arrangement areas LN are located between the adjacent arrangement areas LA, and two of the non-arrangement areas LN are located on an outer side of the arrangement area LA located on each end portion. LED board holders 220 are arranged in two of the non-arrangement areas LN located between the adjacent arrangement areas LA. The LED board holders 220 include a light leading portion 222 extending along the X-axis direction (the arrangement direction of the LEDs 217 included in the LED group 221). The light leading portion 222 extends along the long-side direction of the bottom plate 14a of the chassis 14 over substantially the entire length of the bottom plate 14a.

### Other Embodiments

The present invention is not limited to the above embodiments described in the above description and the drawings. The following embodiments are also included in the technical scope of the present invention, for example.

(1) In the first embodiment and the first modification of the first embodiment, the pair of inclined surfaces of the light leading portion has substantially the same inclination angle. However, the inclination angle of each inclined surface may differ from each other.

(2) In the first embodiment and the first modification of the first embodiment, the inclined surfaces of the light leading portion each having the inclination angle of at least 45 degrees has been explained with reference to the drawings. However, the inclined surface may have the inclination angle of less than 45 degrees. The inclination angle may be properly changed.

(3) In the first embodiment, the cross-sectional shape of the light leading portion is the isosceles triangle. However, the cross-sectional shape of the light leading portion may be a right triangle, an equilateral triangle, or any other triangle than the right triangle and the equilateral triangle.

(4) In the first embodiment and the first modification of the first embodiment, the light leading portion includes the pair of inclined surfaces. However, only one of two side surface of the light leading portion may be the inclined surface.

(5) The cross-sectional shape of the light leading portion may be properly changed from that in the first embodiment and the modifications. For example, the cross-sectional shape of the light leading portion may be a semicircular shape.

(6) The protruding length of the light leading portion from the reflection sheet to the front side may be properly changed from that in the above embodiments. For example, the protruding length may be less than half of the distance between the reflection sheet and the diffuser plate. Alternatively, the protruding length may be the same as or smaller than the producing length of the LED from the LED board.

(7) In the above embodiments, the light source board holder is located at the middle position between the adjacent arrangement areas (the adjacent LED groups). However, according to the technology of the present invention, the light source board holder may be located away from the middle position. The light source board holder may be relatively close to one of the adjacent arrangement areas and relatively far from the other one of the adjacent arrangement areas.

(8) In the above embodiments, the light source board holder is only provided in the non-arrangement area located between the adjacent arrangement areas (the adjacent LED groups). However, according to the technology of the present invention, the light source board holder may be provided in the non-arrangement area that is located on the outer side of the arrangement area located on the end portion.

(9) In the above embodiments, the light source board holder is provided in every non-arrangement area located between the adjacent arrangement areas (the adjacent LED groups). However, the light source board holder may not be provided in every non-arrangement area located between the adjacent arrangement areas.

(10) The number of light source board holders and the arrangement of the light source board holders may be properly changed from the above embodiments.

(11) In the above embodiments, the light source board holder including the light leading portion has a surface having white color. However, the color may be milky white or silver, for example.

(12) In the above embodiments, the LEDs included in the LED group are arranged at equal intervals. However, according to the technology of the present invention, the LEDs included in the LED group may be arranged at unequal intervals.

(13) In the above embodiments, the LED groups are arranged at equal intervals. However, according to the technology of the present invention, the LED groups may be arranged at unequal intervals.

(14) The number of LEDs included in the LED group and the arrangement pitch of the LEDs may be properly changed from those of the above embodiments. Similarly, the number of LED groups arranged in the chassis and the arrangement pitch of the LED groups may be properly changed.

(15) In the above embodiments, the LED board extends over substantially the entire area of the bottom plate of the chassis. However, the specific size of the LED board may be properly changed. For example, the LED board may be smaller than the bottom plate.

(16) In the above embodiments, the reflection sheet has a surface having white color. However, the color may be milky white or silver, for example.

(17) In the above embodiments, the backlight unit includes the reflection sheet. However, the backlight unit may not include the reflection sheet. Preferably, in such a case, a light reflection portion that has high light reflectivity may be provided on a surface of the LED board.

(18) The number of mounting portions included in the light source board holder and the arrangement of the mounting portions may be properly changed from that in the above embodiments.

(19) In the above embodiments, the light source board holder includes the mounting portions. However, the light source board holder may not include the mounting portions. In such a case, the light source board holder may be directly fixed to the bottom plate with glue, for example.

(20) In the above embodiments, the liquid crystal panel and the chassis are arranged in a vertical position such that the short-side direction of the liquid crystal panel and the chassis matches the vertical direction. However, the liquid crystal panel and the chassis are arranged in a vertical position such that the long-side direction thereof matches the vertical direction.

(21) In the above embodiments, TFTs are used as switching components of the liquid crystal display device. However, the technology described above can be applied to liquid crystal display devices including switching components other than TFTs (e.g., thin film diode (TFD)). Moreover, the technology can be applied to not only color liquid crystal display devices but also black-and-white liquid crystal display devices.

(22) In the above embodiments, the liquid crystal display device including the liquid crystal panel as a display panel is used. However, the technology can be applied to display devices including other types of display panels.

(23) In the above embodiments, the television receiver including the tuner is used. However, the technology can be applied to a display device without a tuner.

### EXPLANATION OF SYMBOLS

10: liquid crystal display device (display device), 11: liquid crystal panel (display panel), 12: backlight unit (lighting device), 14: chassis, 14a: bottom plate, 14e: mounting through hole, 15: optical member, 17, 217: LED (light source), 18, 218: LED board (light source board), 19: reflection sheet (reflection member), 20, 120, 220: LED board holder, 21, 221: LED group (light source group), 22, 122, 222: light leading portion, 22a: inclined surface, 23: mounting portion, C: clearance, LA: arrangement area of light source, LN: non-arrangement area of light source, TV: television receiver

1. A lighting device comprising:
a light source;
a light source board on which the light source is mounted;
a chassis housing the light source board, the chassis including a bottom plate on which the light source board is arranged, the bottom plate including at least one arrangement area in which the light source is arranged and at least one non-arrangement area in which no light source is arranged; and
a light source board holder fixed to the bottom plate in the non-arrangement area such that the light source board is sandwiched between the light source board holder and the bottom plate, the light source board holder including a light leading portion protruding toward a light exit side so as to be away from the light source board, the light leading portion being configured to lead light from the light source toward the light exit side.

2. The lighting device according to claim 1, wherein the light leading portion includes an inclined surface inclined with respect to a surface of the bottom plate and oriented to the arrangement area.

3. The lighting device according to claim 1, wherein:
the light source includes a plurality of light sources and the at least one arrangement area includes at least two arrangement areas, and the at least two arrangement areas are located to sandwich the at least one non-arrangement area therebetween; and
the inclined surface includes a pair of inclined surfaces, and each of the inclined surfaces is oriented to each of the at least two arrangement areas located to sandwich the non-arrangement area therebetween.

4. The lighting device according to claim 3, wherein the inclined surfaces have a substantially equal inclination angle.

5. The lighting device according to claim 3, wherein the light leading portion has a triangular cross-sectional shape.

6. The lighting device according to of claim 1, wherein the light leading portion protrudes farther than the light source to be away from the light source board toward the light exit side.

7. The lighting device according to of claim 1, wherein the light leading portion includes a surface having white color.

8. The lighting device according to claim 1, wherein:
the light source includes a plurality of light sources, and the light sources are linearly arranged on the light source board to form a light source group;
the arrangement area of the light sources has a band shape extending along an arrangement direction of the light sources in which the light sources included in the light source group are arranged; and
the light leading portion extends along the arrangement direction.

9. The lighting device according to claim 8, wherein the light leading portion extends parallel with the light source group over an entire length of the light source group.

10. The lighting device according to claim 8, wherein:
the bottom plate has an elongated shape; and
the arrangement direction of the light sources included in the light source group matches a short-side direction of the bottom plate.

11. The lighting device according to claim 8, wherein:
the light source group includes a plurality of light source groups, and the light source groups are spaced apart from each other in a direction intersecting with the arrangement direction of the light sources; and
the light source board holder is arranged between adjacent light source groups.

12. The lighting device according to claim 11, wherein the light source board holder is arranged at a middle position between the adjacent light source groups.

13. The lighting device according to claim 11, wherein the light sources adjacent to each other in the arrangement direction of the light sources have an interval therebetween that is smaller than an interval between the light source groups adjacent to each other.

14. The lighting device according to claim 13, wherein the interval between the adjacent light sources in the arrangement direction of the light sources is smaller than an interval between the light source and the light leading portion of the light source board holder.

15. The lighting device according to claim 11, wherein the light source groups are arranged in the direction intersecting with the arrangement direction of the light sources at substantially equal intervals.

16. The lighting device according to claim 8, wherein the light sources included in the light source group are arranged in the arrangement direction at substantially equal intervals.

17. The lighting device according to claim 1, further comprising a reflection member covering the light source board from the light exit side, the reflection member being configured to reflect the light emitted from the light source toward the light exit side.

18. The lighting device according to claim 17, wherein the reflection member and the light source board are sandwiched between the light source board holder and the bottom plate.

19-23. (canceled)

24. A display device comprising:
a lighting device according to claim 1; and
a display panel configured to provide display using light from the lighting device.

25. (canceled)

26. A television receiver comprising the display device according to claim 24.
